(19) United States
(12) Patent Application Publication
(10) Pub. No.: US 2013/0280470 A1
(43) Pub. Date: Oct. 24, 2013

(54) Thermal Management For Aircraft Composites

(71) Applicant: Julian Norly, Chagrin Falls, OH (US)

(72) Inventor: Julian Norly, Chagrin Falls, OH (US)

(21) Appl. No.: 13/451,904

(22) Filed: Apr. 20, 2012

(51) Int. Cl. B32B 1/06

(52) U.S. Cl. 428/76; 428/68

(57) ABSTRACT

A composite article including a fiber-reinforced resin composite having an internal portion, and an internal surface and an external surface; and a thermal article formed of an anisotropic graphite sheet having a thermo-mechanical design constant of at least 10 mm-W/m*K, the thermal article positioned in the internal portion of the fiber-reinforced resin composite, wherein the thermo-mechanical design constant of a material is defined by thermal conductivity of the material multiplied by its average thickness.

### BACKGROUND OF THE INVENTION

1. Technical Field

The present disclosure relates to thermal management for aircraft composites, especially composites used as an aircraft skin behind which electronics are arrayed, such as the housing and/or nosecone of a missile or jet. More specifically, the present disclosure relates to a shaped or molded composite article suitable for use as the nosecone or other structure of an aircraft, the composite having an anisotropic heat spreader in thermal contact with therewith.

2. Background

The nosecones and other structures of missiles and other types of aircraft contain several kinds and types of electronics, such as guidance equipment, radar arrays, radio frequency (RF) transmitters and receivers, communications equipment, etc. As with many electronics, they are temperature sensitive and excessive heat can interfere with and degrade performance. The housings surrounding the electronics are generally manufactured from aluminum, and thermal protection of the electronics is commonly done by sinking heat from the electronics to the aluminum.

There is a desire to replace the aluminum with carbon fiber-reinforced resin composites to reduce the weight of the structure and to avoid the electronic and radio-frequency interference or attenuation which can be occasioned by an aluminum body. However, the typical resin composites, such as polyacrylonitrile (PAN)-based carbon fiber epoxy composites, have thermal conductivity significantly lower than aluminum, so cooling the electronics now becomes a problem.

Taking the case of a missile nosecone in particular, when a composite is used to replace the aluminum, the nosecone includes an assembly that has a single-piece composite material forebody that is coupled to a missile body of the missile. The forebody is made of a high-temperature composite material that can withstand heat with little or no ablation. The forebody has a front part with an ogive shape and an aft part that has a cylindrical shape. The ogive front part acts as a radome for a seeker located within the forebody. Patch antennas are attached to an inside surface of the cylindrical aft part. The aft part acts as a radome for the patch antennas, allowing signals to be sent and received by the patch antennas without a need for cutouts. A single seal may be used to seal the guidance system and seeker within the forebody, allowing the guidance system and seeker to be hermetically sealed within the forebody. Compared with prior art aluminum systems, a carbon fiber-reinforced resin composite forebody reduces the number of parts, manufacturing complexity, weight, and cost.

The composite material may be a resin which is reinforced with a fiber which can be aramid, carbon, glass, quartz or graphite. Such a composite functions as both a non-ablative thermal protection system for all of the electronics within the nosecone, as well as a frontal and conformal radiatively-transparent radome for the seeker.

The resin for the composite material may be a suitable thermoset resin, for example one or more of epoxy, bismaleimide (BMI), cyanate esters (CE), polyimide (PI), the resin may be a suitable thermoplastic, or a non-organic silicone-based material, such as polysiloxane.

In order to form a fiber-reinforced resin into the nosecone (or, indeed, any aircraft component), fibers in thread form are wound about a form or mandrel having the desired shape of the forebody; resin is then spread in and around the wound threads, and the structure is heated to cure the resin. The forebody may be built up in multiple layers, each of the layers being separately formed by winding fiber thread, introducing resin, and curing the resin. For instance, different steps may be used for building up parts of the composite material that do and do not contain fibers. Alternatively, the forebody may be built in a single step, either with all fibers of the same type, or employing fibers of different types. The forebody is advantageously cured in a single curing process.

In a different embodiment, the fibers (whether all of the same time, or combinations of different types), can be pre-impregnated with the desired resin, and the resin/fiber composite then wrapped around or otherwise applied to the mandrel. Again, curing is advantageously accomplished in a single curing process after application to the mandrel.

Other methods of forming composite material articles include use of resin transfer molding, tape placement, and compression molding. It will be appreciated that details are well known for processes used for fabricating composite material articles. Further details regarding methods for fabricating composite material articles may be found in U.S. Pat. Nos. 7,681,834, 5,483,894, 5,824,404, and 6,526,860, the descriptions and figures of which are incorporated herein by reference.

However, as noted, substituting a fiber-reinforced resin composite for the traditional aluminum used to form an aircraft skin behind which electronics are arrayed results in a loss of the heat sinking properties of the aluminum. The use of an anisotropic graphite sheet internal to the resin composite can help overcome these issues.

Graphite flake which has been greatly expanded and more particularly expanded so as to have a final thickness or “c” direction dimension which is as much as about 80 or more times the original “c” direction dimension can be formed without the use of a binder into cohesive or integrated sheets of expanded graphite, e.g. webs, papers, strips, tapes, foils, mats or the like (typically referred to commercially as “flexible graphite”). The formation of graphite particles which have been expanded to have a final thickness or “c” dimension which is as much as about 80 times or more the original “c” direction dimension into integrated flexible sheets by compression, without the use of any binding material, is believed to be possible due to the mechanical interlocking, or cohesion, which is achieved between the voluminously expanded graphite particles.

In addition to flexibility, the sheet material, as noted above, has also been found to possess a high degree of anisotropy with respect to thermal conductivity due to orientation of the expanded graphite particles and graphite layers substantially parallel to the opposed faces of the sheet resulting from high compression, making it especially useful in heat spreading applications. Sheet material thus produced has excellent flexibility, good strength and a high degree of orientation.

The flexible graphite sheet material exhibits an appreciable degree of anisotropy due to the alignment of graphite particles parallel to the major opposed, parallel surfaces of the sheet, with the degree of anisotropy increasing upon compression of the sheet material to increase orientation. In compressed anisotropic sheet material, the thickness, i.e. the direction perpendicular to the opposed, parallel sheet surfaces comprises the “c” direction and the directions ranging along the length and width, i.e. along or parallel to the opposed, major surfaces comprises the “a” directions and the thermal and electrical properties of the sheet are very different, by orders of magnitude, for the “c” and “a” directions.

Pyrolytic graphite and graphitized polyimide are forms of synthetic graphite which exhibit anisotropic properties. In one embodiment, pyrolyzed graphite is produced by heating a polymer nearly to its decomposition temperature, and permitting the graphite to crystallize (pyrolysis). One method is to heat synthetic fibers in a vacuum. Another method is to place seeds or a plate in the very hot gas to collect the graphite coating. Pyrolytic graphite sheets usually have a single cleavage plane, similar to mica, because the graphene sheets crystallize in a planar order. Graphitized polyimide refers to graphite films with high crystallinity and which can be created by the solid-state carbonization of an aromatic polyimide film followed by a high temperature heat treatment. Graphitized polyimide films also exhibit significant thermal anisotropy.

### BRIEF DESCRIPTION

In an embodiment, the present disclosure relates to a composite article which comprises a fiber-reinforced resin composite having a thermal article which comprises at least one anisotropic sheet of graphite positioned internal thereto, such as on an internal surface thereof. In some embodiments, the fiber-reinforced resin composite is shaped so as to have an internal portion, including an internal surface and an external surface, where the thermal article is positioned on the internal surface of the fiber-reinforced resin composite. In still other embodiments, the disclosure relates to an aircraft part, such as the nosecone or housing of a missile, or the wing section, tail section, fuselage, or other structural component of an airplane, especially a jet airplane, and which comprises a fiber-reinforced resin composite shaped so as to have an internal surface and an external surface, where a thermal article which comprises at least one anisotropic sheet of graphite is positioned on the internal surface of the fiber-reinforced resin composite.

In many embodiments, the graphite sheet used herein has an in-plane thermal conductivity of at least about 140 W/m*K, more preferably at least about 220 W/m*K (all thermal conductivity measurements provided herein, whether of expanded natural graphite or synthetic graphite, are taken at room temperature, ˜20° C., by the Angstrom method as described in The Thermal Performance of Natural Graphite Heatspreaders, by Smalc et al., presented at the July 2005 ASME InterPack Conference, paper no. 2005-73073; it will be recognized that other methods of measuring thermal conductivity can also be employed). The at least one sheet of graphite is anisotropic, as discussed above, and should be at least about 0.01 mm in thickness, up to about 2 mm in thickness. Most commonly, the graphite sheet is from about 0.075 mm to about 1 mm in thickness.

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated in and constitute a part of this specification. The drawings illustrate various embodiments of the invention and together with the description serve to explain the principles and operations of the invention. Other and further features and advantages of the present invention will be readily apparent to those skilled in the art upon a reading of the following disclosure when taken in conjunction with the accompanying drawings.

### BRIEF DESCRIPTION OF THE DRAWINGS

FIG. 1 is a partially broken-away, side plan view of an embodiment of a composite article in accordance with the present disclosure.

FIG. 2 is a side plan view of an embodiment of a missile having the composite article of FIG. 1 in place as a nosecone thereof.

FIG. 3 is a partially broken-away, side plan view of another embodiment of a composite article in accordance with the present disclosure.

FIG. 4 is a partially broken-away, side plan view of still another embodiment of a composite article in accordance with the present disclosure.

FIG. 5A is a perspective view of a mandrel used in the production of a composite article in accordance with the present disclosure, at one stage during the production process.

FIG. 5B is a perspective view of a mandrel used in the production of a composite article in accordance with the present disclosure, at another stage during the production process.

### DETAILED DESCRIPTION

As noted, the present disclosure relates to a composite article which comprises a fiber-reinforced resin composite having a thermal article comprising at least one anisotropic sheet of graphite positioned internal to the fiber-reinforced resin composite, especially on an internal surface thereof. In certain embodiments, the disclosure relates to an aircraft part, such as the nosecone or housing of a missile, which comprises a fiber-reinforced resin composite shaped so as to have an internal portion and an internal surface and an external surface, where a thermal article which comprises at least one anisotropic sheet of graphite is positioned in the internal portion of the fiber-reinforced resin composite, especially on the internal surface of the fiber-reinforced resin composite. As used herein, the term “aircraft” refers to any man-made flying object, whether manned or unmanned, guided or ballistic, and whether launched from the ground, at sea, or launched from another aircraft. Included within the contemplation of this disclosure are missiles, ballistic and otherwise, and commercial, civilian, governmental and military airplanes, whether jet, propeller or rocket propelled.

In many embodiments, the thermal article used herein has an in-plane thermal conductivity of at least about 140 W/m*K, more preferably at least about 220 W/m*K, and even more advantageously at least 300 W/m*K; in some embodiments, the thermal article has an in-plane thermal conductivity of at least about 400 W/m*K, at least about 500 W/m*K and/or at least about 600 W/m*K. While there is no functional upper limit for the in-plane thermal conductivity of the heat spreader, there is no practical need for it to be higher than about 2000 W/m*K. In addition, the thermal article is thermally anisotropic. By anisotropic is meant that the material has a thermal anisotropic ratio (defined as the ratio of the thermal conductivity along the plane of the sheet to the thermal conductivity through the plane of the sheet, orthogonal to in-plane thermal conductivity) of at least 1.0, preferably at least 1.5, more preferably at least 2.0. In a certain embodiment, the thermal anisotropic ratio of the thermal article may range from about 10 up to about 1000, or higher. The thermal article should be at least about 0.01 mm in thickness, up to about 2 mm in thickness. Most commonly, the thermal article is from about 0.075 mm to about 1 mm in thickness.

In advantageous embodiments, the thermal article has a thermo-mechanical design constant which differs from that of the fiber-reinforced resin composite. As used herein, the expression “thermo-mechanical design constant” refers to a characteristic of a material having two major surfaces represented by the average thickness of the material (i.e., the distance between the two major surface of the material) multiplied by its in-plane thermal conductivity, and can be used as a measure of the thermal capability of the material (the “amount” of heat the material can dissipate). Preferably, the material from which the thermal article is formed has a thermo-mechanical design constant that is no less than 50% that of the thermo-mechanical design constant of the fiber-reinforced resin composite; in other embodiments, the thermal article has a thermo-mechanical design constant that is at least 30% greater than the thermo-mechanical design constant of the fiber-reinforced resin composite, more preferably at least 50% greater than the thermo-mechanical design constant of the fiber-reinforced resin composite, in order to effectively dissipate and spread heat generated during operation of the aircraft. In some embodiments, the thermal article material has a thermo-mechanical design constant of at least 10 mm-W/m*K, more preferably at least 145 mm-W/m*K, even more preferably at least 200 mm-W/m*K, or at least 350 mm-W/m*K. In certain preferred embodiments, the thermal article has a thermo-mechanical design constant of at least 580 mm-W/m*K. In other embodiments, suitable thermo-mechanical design constants of the thermal article may include at least about 20 mm-W/m*K, at least about 50 mm-W/m*K, at least about 75 mm-W/m*K, and at least about 100 mm-W/m*K.

In some embodiments, the thermal article is formed of at least one sheet of compressed particles of exfoliated graphite. Graphite is a crystalline form of carbon comprising atoms covalently bonded in flat layered planes with weaker bonds between the planes. By treating particles of graphite, such as natural graphite flake, with an intercalant of, e.g. a solution of sulfuric and nitric acid, the crystal structure of the graphite reacts to form a compound of graphite and the intercalant. The treated particles of graphite are hereafter referred to as “particles of intercalated graphite.” Upon exposure to high temperature, the intercalant within the graphite decomposes and volatilizes, causing the particles of intercalated graphite to expand in dimension as much as about 80 or more times its original volume in an accordion-like fashion in the “c” direction, i.e. in the direction perpendicular to the crystalline planes of the graphite. The exfoliated graphite particles are vermiform in appearance, and are therefore commonly referred to as worms. The worms may be compressed together into flexible sheets that, unlike the original graphite flakes, can be formed and cut into various shapes. One graphite sheet suitable for use as the thermal article in the present disclosure is commercially available as eGRAF material, from GrafTech International Holdings Inc. of Parma, Ohio.

In certain embodiments, the thermal article of the present disclosure is formed of at least one sheet of synthetic graphite. As used in the present disclosure, the term “synthetic graphite” refers to graphitic materials having an in-plane thermal conductivity of at least about 700 W/m*K, and which can be as high as about 1500 W/m*K, or even as high as 2000 W/m*K or higher. Exemplary of such materials are those graphite materials referred to as pyrolytic graphite and graphitized polyimide films. Typically, these synthetic graphite materials have a thickness of at least about 20 microns, up to about 90 microns, and a density that can be between about 2.0 g/cc and about 2.25 g/cc.

By “pyrolytic graphite” is meant a graphitic material formed by the heat treatment of certain polymers as taught, for instance, in U.S. Pat. Nos. 3,317,338 and 4,054,708, the disclosures of which are incorporated herein by reference. In some embodiments, pyrolytic graphite refers to the carbon material produced through a gas-phase carbonization process. The gas-phase deposition of carbon occurs on a surface through the contact of hydrocarbons upon a substrate through the pyrolysis of hydrocarbons in the gas phase and deposition on the substrate surface. The large aromatic molecules produced by dehydrogenation and polymerization of hydrocarbons collide with the high-temperature substrate surface to form the deposit. Hydrogen is often used as a carrier gas with propane as a potential raw material with the concentration of propane depending upon the selected temperature and pressure conditions. The specific conditions of the reaction are selected for the prevention of soot and production of depositions, typically keeping the hydrocarbon gas at the lowest possible temperature where carbonization is completed when the gas contacts the substrate surface.

Graphitized polyimide film can be made from a polymer material as taught, for instance, in U.S. Pat. No. 5,091,025, the disclosure of which is incorporated herein by reference. Specifically, graphite films with high crystallinity can be created by the solid-state carbonization of an aromatic polyimide film followed by a high temperature heat treatment. In the production of graphitized polyimide, a film such as a polyimide film is first cut and shaped to anticipate the subsequent shrinkage during the carbonization step. During carbonization, a large amount of carbon monoxide may evolve from the film accompanied by a substantial shrinkage of the film (often shrinkages substantially greater than 30% are observed).

The carbonization may take place as a two step process, the first step at a substantially lower temperature than the second step. During the first step of carbonizing a polyimide film, which occurs by bringing the film to a temperature of at least about 600° C., up to about 1800° C., over the course of at least two hours and up to about seven hours. The graphitization process includes a high temperature (i.e., at least 2000° C. and up to about 3200° C.) heat treatment with the temperature of the heat treatment resulting in different alignment of the carbon atoms. Specifically, dependent upon the selected film, pores exist between the carbon layer stacks after graphitization at certain temperatures. For example, at 2450° C., a polyimide film, after the graphitization step, may still be turbostratic as flattened pores are oriented between the carbon layers. Conversely, at 2500° C., the same film would have the pores collapse resulting in a graphitic film with virtually perfect carbon layers. Sources of such graphitized polyimide film are Panasonic's PGS graphite sheet as well as GrafTech International Holdings Inc. SS1500 heat spreader.

When employed as a thermal article in accordance with the current disclosure, a sheet of graphite should have a density of at least about 0.6 g/cc, more preferably at least about 1.1 g/cc, most preferably at least about 1.6 g/cc. From a practical standpoint, the upper limit to the density of the graphite sheet heat spreader is about 2.25 g/cc. The sheet should be no more than about 10 mm in thickness, more preferably no more than about 2 mm and most preferably not more than about 0.5 mm in thickness. When more than one sheet is employed, the total thickness of the sheets taken together should preferably be no more than about 10 mm. In certain embodiments, when a plurality of sheets of graphite are employed as the thermal article, they are either all sheets of compressed particles of exfoliated graphite or all sheets of synthetic graphite. Alternately, when a plurality of sheets of graphite are employed as the thermal article, they can be combinations of sheets of compressed particles of exfoliated graphite and sheets of synthetic graphite.

In certain embodiments, a plurality of graphite sheets may be laminated into a unitary article for use in the thermal article disclosed herein. The sheets of graphite can be laminated with a suitable adhesive, such as pressure sensitive or thermally activated adhesive, therebetween. The adhesive chosen should balance bonding strength with minimizing thickness, and be capable of maintaining adequate bonding at the service temperature at which heat transfer is sought. Suitable adhesives would be known to the skilled artisan, and include acrylic and phenolic resins.

The graphite sheet(s) should have a thermal conductivity parallel to the plane of the sheet (referred to as “in-plane thermal conductivity”) of at least 140 W/m*K for effective use. More advantageously, the thermal conductivity parallel to the plane of the graphite sheet(s) is at least 220 W/m*K, most advantageously at least 300 W/m*K. In certain embodiments, the graphite sheet(s) should have an in-plane thermal conductivity of at least about 400 W/m*K, at least about 500 W/m*K, or even as high as 600 W/m*K or higher. From a practical standpoint, sheets of graphite having an in-plane thermal conductivity of up to about 2000 W/m*K are all that are necessary.

In addition to the in-plane thermal conductivity of the anisotropic sheet(s) of graphite, the through-plane thermal conductivity is also relevant. In certain embodiments, the through-plane thermal conductivity of the sheet of graphite should be less than 12 W/m*K; in other embodiments, the through-plane thermal conductivity is less than 10 W/m*K. In still other embodiments, the through-plane thermal conductivity of the sheet of graphite is less than 7 W/m*K. In a particular embodiment, the through-plane thermal conductivity of the sheet is at least about 1.5 W/m*K.

The expressions “thermal conductivity parallel to the plane of the sheet”, “thermal conductivity along the plane of the sheet” and “in-plane thermal conductivity” all refer to the fact that a sheet of compressed particles of exfoliated graphite has two major surfaces, which can be referred to as forming the plane of the sheet; thus, thermal conductivity parallel to or along the plane of the sheet and in-plane thermal conductivity constitute the thermal conductivity along the major surfaces of the sheet of compressed particles of exfoliated graphite. The expression “through-plane thermal conductivity” refers to the thermal conductivity between or orthogonal to the major surfaces of the sheet.

In order to access the anisotropic properties of the graphite sheet, in some embodiments, the thermal anisotropic ratio of the sheet may be at least about 50; in other embodiments, the thermal anisotropic ratio of the sheet is at least about 70. Generally, the thermal anisotropic ratio need not be any greater than about 600, more preferably no greater than about 300.

In certain embodiments, the thermal article can be coated with a layer of an electrically insulating material, such as a plastic like polyethylene terephthalate (PET), for electrical isolation.

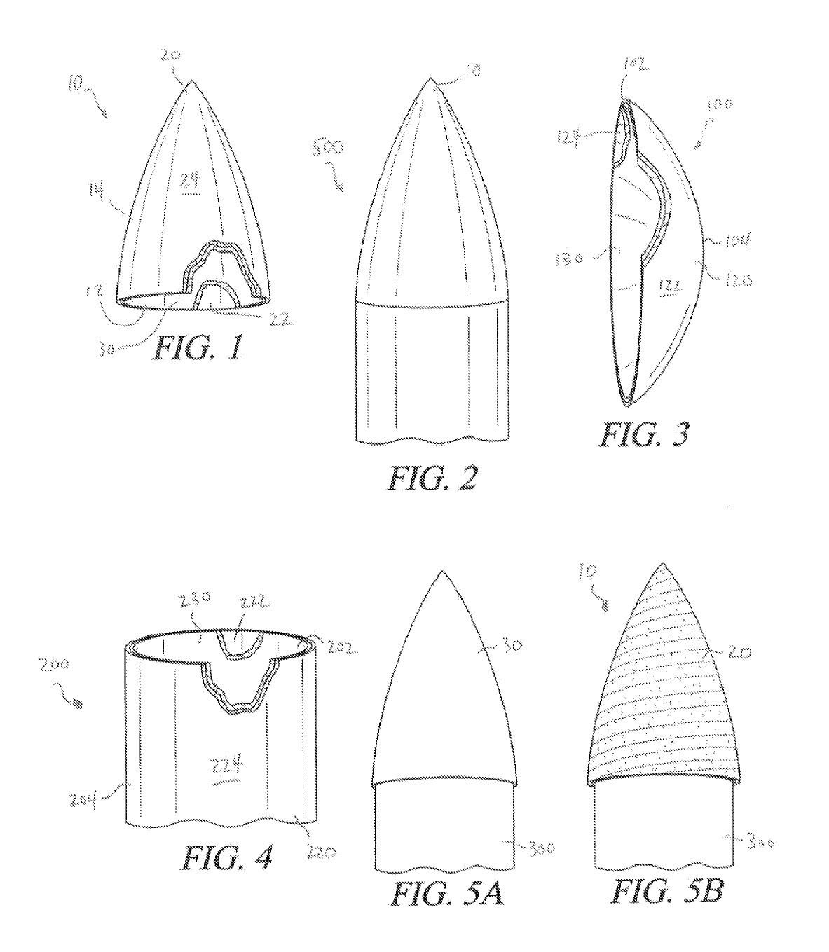

Referring now to the drawings, in which not all reference numbers are shown in every drawing, for clarity purposes, FIG. 1 shows an aircraft part in accordance with the disclosure, denoted by the reference numeral 10. In FIG. 1, aircraft part 10 is shaped so as to be appropriate for use as a missile nosecone, and includes an internal portion 12 and an external portion 14. Aircraft part 10 comprises a fiber-reinforced resin composite 20 having an internal surface 22 and an external surface 24, and a thermal article 30, wherein thermal article 30 is positioned in thermal contact with the internal surface 22 of fiber-reinforced resin composite 20. By thermal contact is meant that thermal article 30 is positioned with respect to the internal surface 22 of fiber-reinforced resin composite 20 such that heat is transferred therebetween. In some embodiments, thermal article 30 is adhesively bonded to fiber-reinforced resin composite 30. In other embodiments, thermal article 30 is frictionally maintained in position in relation to fiber-reinforced resin composite 30. In still other embodiments, thermal article 30 is located internal to fiber-reinforced resin composite 20, adjacent to internal surface 22. FIG. 2 illustrates aircraft part 10 when positioned as part of a missile 500.

FIG. 3 shows another embodiment of an aircraft part in accordance with the present disclosure, denoted 100. Aircraft part 100 includes internal and external portions, 102 and 104, respectively, internal and external surfaces, 122 and 124, respectively. Furthermore, aircraft part 100 comprises fiber-reinforced resin composite 120 and thermal article 130, and is shaped so as to be appropriate for use as the randome of a jet (not shown).

FIG. 4 shows another embodiment of an aircraft part in accordance with the present disclosure, denoted 200. Aircraft part 200 includes internal and external portions, 202 and 204, respectively, and comprises fiber-reinforced resin composite 220 and thermal article 230. Moreover, aircraft part 200 includes internal surface 222 and external surface 224, and is shaped so as to be appropriate for use as the housing of a missile (not shown).

FIGS. 5A and 5B illustrate one manner of production of aircraft part 10, in which a mandrel 300 is employed. Thermal article 30 is applied to mandrel 300, and fiber-reinforced resin composite 20 is then formed over thermal article 30, to form aircraft part 10.

Thus, by the practice of the foregoing disclosure, the aluminum used in the nosecone or other aircraft part can be replaced with a fiber-reinforced resin composite, while maintaining the thermal advantages of the use of aluminum.

All cited patents and publications referred to in this application are incorporated by reference.

The disclosure thus being described, it will be apparent that it may be varied in many ways. Such variations are not to be regarded as a departure from the spirit and scope of the present disclosure and all such modifications as would be obvious to one skilled in the art are intended to be included in the scope of the following claims.

What is claimed is:

1. An aircraft part, comprising
a. a fiber-reinforced resin composite having an internal portion, and an internal surface and an external surface; and
b. a thermal article which comprises an anisotropic graphite sheet having a thermo-mechanical design constant of at least 10 mm-W/m*K, the thermal article positioned in the internal portion of the fiber-reinforced resin composite, wherein the thermo-mechanical design constant of a material is defined by thermal conductivity of the material multiplied by its average thickness.

2. The aircraft part of claim 1, wherein the thermal article is in thermal contact with the internal surface of the fiber-reinforced resin composite.

3. The aircraft part of claim 1, wherein the thermal article comprises at least one sheet of compressed particles of exfoliated graphite.

4. The aircraft part of claim 3, wherein the thermal article has an in-plane thermal conductivity of at least about 140 W/m*K.

5. The aircraft part of claim 1, wherein the thermal article comprises at least one sheet of a synthetic graphite material selected form the group consisting of pyrolytic graphite and graphitized polyimide.

6. The aircraft part of claim 5, wherein the thermal article has an in-plane thermal conductivity of at least about 700 W/m*K.

7. The aircraft part of claim 1, wherein the thermo-mechanical design constant of the thermal article is no less than 50% of the thermo-mechanical design constant of the fiber-reinforced resin composite.

8. The aircraft part of claim 1, the thermal anisotropic ratio of the thermal article is at least 10.

9. The aircraft part of claim 1, wherein the thickness of the thermal article ranges from about 0.01 mm to about 2 mm.

10. An composite article, comprising
a. a fiber-reinforced resin composite having an internal surface and an external surface; and
b. a thermal article which comprises an anisotropic graphite sheet having a thermo-mechanical design constant of at least 10 mm-W/m*K, the thermal article positioned in thermal contact with the internal surface of the fiber-reinforced resin composite,
wherein the thermo-mechanical design constant of a material is defined by thermal conductivity of the material multiplied by its average thickness.

11. The composite article of claim 10, wherein the thermal article comprises at least one sheet of compressed particles of exfoliated graphite.

12. The composite article of claim 11, wherein the thermal article has an in-plane thermal conductivity of at least about 140 W/m*K.

13. The composite article of claim 10, wherein the thermal article comprises at least one sheet of a synthetic graphite material selected form the group consisting of pyrolytic graphite and graphitized polyimide.

14. The composite article of claim 13, wherein the thermal article has an in-plane thermal conductivity of at least about 700 W/m*K.

15. The composite article of claim 10, wherein the thermo-mechanical design constant of the thermal article is no less than 50% of the thermo-mechanical design constant of the fiber-reinforced resin composite.

16. The composite article of claim 10, the thermal anisotropic ratio of the thermal article is at least 10.

17. The composite article of claim 10, wherein the thickness of the thermal article ranges from about 0.01 mm to about 2 mm.
